(19) United States
(12) Patent Application Publication
(10) Pub. No.: US 2017/0107770 A1
(43) Pub. Date: Apr. 20, 2017

(54) INTERFACE

(71) Applicant: Trelleborg Offshore U.K. Ltd., Lancashire (GB)

(72) Inventors: Austin Harbison, Lancashire (GB); Muhammad Aqib Maqbool, Lancashire (GB)

(73) Assignee: Trelleborg Offshore U.K. Ltd., Lancashire (GB)

(21) Appl. No.: 15/123,531

(22) PCT Filed: Jan. 9, 2015
(86) PCT No.: PCT/GB2015/050042

§ 371 Date: Sep. 2, 2016

(30) Foreign Application Priority Data
Jan. 9, 2014 (GB) 1400374.3

(51) Int. Cl. E21B 17/01; F16L 27/02; F16L 1/12

(52) U.S. Cl. CPC E21B 17/017; F16L 1/123; F16L 27/02

(57) ABSTRACT

A bend restrictor segment comprises a female end and a mate end, wherein the female end is suitable for locating around the male end of a further bend restrictor segment and the male end is suitable for locating inside the female end of a further bend restrictor segment. The bend restrictor segment is adapted to be suitable for coupling, in either orientation, to an interface unit.

The field of the present invention is bend restrictors in the offshore and oil industries. This invention relates to a bend restrictor interface, a modified interface unit, and a modified bend restrictor segment.

In many offshore environments a bend restrictor is often retrofitted around flexible pipes, umbilicals and/or power cables to prevent such flexible pipework from overbending. Such a bend restrictor is designed to ensure that the maximum curvature limits of the flexible pipework are not exceeded. Known bend restrictors usually comprise a string of identical interlocking elements which articulate when subjected to an external load and lock together to form a smooth curved “locking” radius. This radius is chosen to be equal to or greater than the minimum bend radius of the pipework that it is applied to.

The interlocking elements of the bend restrictor can effectively lock together, and any bending moment present is transferred into the elements and back through a specially designed steel interface structure into the adjacent rigid structure from where the pipework originates, therefore protecting the pipework from potentially damaging loads.

In particular, this invention relates to a bend restrictor interface where a bend restrictor, for example containing a flexible pipework, flowline, power cable and/or umbilical from a rigid structure, such as a subsea riser base, PLEM (pipeline end manifold) or wellhead, is connect to an end termination.

In practice, once the bend restrictor elements have been selected it is then necessary to design the suitable steel interface structure to attach the elements to the adjacent rigid structure. This often requires complex interface engineering with the pipe/umbilical supplier, subsea equipment designers and installation contractors all wishing to have an input into the design process to ensure ease of construction, installation and integrity in service. Since these interfaces are of often of a bespoke construction, this can lead to lengthy weld qualification phases and fabrication times.

Known interface structures comprises a split steel component which has a housing which fits around the heel end of the bend restrictor element, and then bolts or clamps to the adjacent structure. This is a “female” interface connection. Alternatively, a “male” interface connection can be used where the bend restrictor elements fit over the interface steelwork. Bend restrictors can be assembled towards or away from the interface, and conventionally the two options have required different types of interface structure because one requires a male connection and the other a female connection.

FIG. 1 shows a prior art ‘male’ interface structure which connects the end termination 10 (e.g. of a flexible pipework) to the first element 14a of a bend restrictor by way of a segmented male interface 12a, 12b. One end of the segmented male interface 12a, 12b includes a segmented flange 18a, 18b which can also be used to connect with the rigid structure (not shown) from which the pipework emanates.

Situated at the opposite end of the segmented male interface 12a, 12b is a segmented collar 20a, 20b which extends within a channel inside the first element 14a of a bend restrictor string. Longitudinally neighbouring elements 14′a, 14′b of a bend restrictor string are then assembled together.

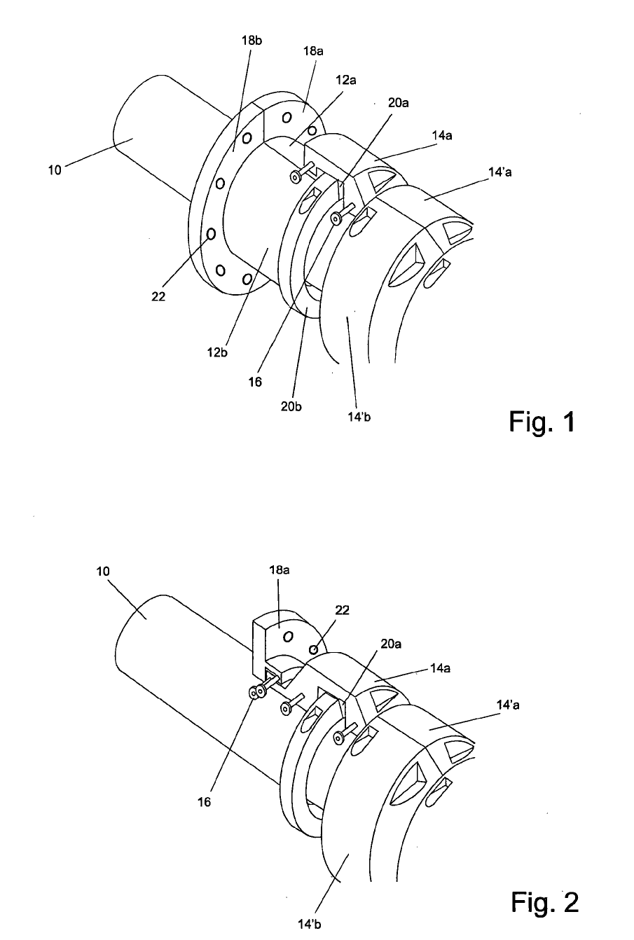

FIG. 2 shows an alternative prior art design which is a segmented “female” interface 12a which fits around the heel end of the first bend restrictor element 14a, and then bolts or clamps to the adjacent rigid structure (not shown) via segmented flange 18a, 18b.

As can be seen from FIGS. 1 and 2, the assembly direction is dependent on the installation sequence, which can, at times, change during the project, causing delays.

It is therefore an object of the present invention to provide a bend restrictor interface which overcomes or reduces the drawbacks associated with known products of this type. The present invention providing a bend restrictor interface which reduces the need for welding and permits assembly both to and from the end termination irrespective of the assembly procedure.

From a first aspect the present invention provides a bend restrictor segment with a female end and a male end, wherein the female end is suitable for locating around the male end of a further bend restrictor segment and the male end is suitable for locating inside the female end of a further bend restrictor segment, and wherein the bend restrictor segment is adapted to be suitable for coupling, in either orientation, to an interface unit.

From further aspects the present invention provides further bend restrictor segments, and interface units, interfaces, assemblies, and methods of assembly, as disclosed herein and in the claims.

The interface unit may be a rigid unit with a bore, such that the bore of the interface unit and the bore of the bend restrictor segments together provide a passage or conduit for a flexible member, e.g. flexible pipework, umbilical, or power cable. In this way the flexible member may exit the main structure and flow through the interface unit and bend restrictor. The interface unit may be generally tubular or cylindrical.

An advantage of using the bend restrictor interface of the present invention for connecting the end termination of a flexible pipework from a rigid structure to a bend restrictor is that some welding steps are no longer necessary.

A bend restrictor string can be readily assembled and which permits assembly both to and from the end termination irrespective of the assembly procedure.

It will be obvious to those skilled in the art that variations of the present invention are possible and it is intended that the present invention may be used other than as specifically described herein.

Specific non-limiting embodiments of the invention will now be described by way of example only and with reference to the accompanying drawings, in which:

FIG. 1 is a side perspective view of a prior art “male” interface structure for coupling an end termination with a bend restrictor string;

FIG. 2 is a side perspective view of a prior art “female” interface structure for coupling the an termination with a bend restrictor string;

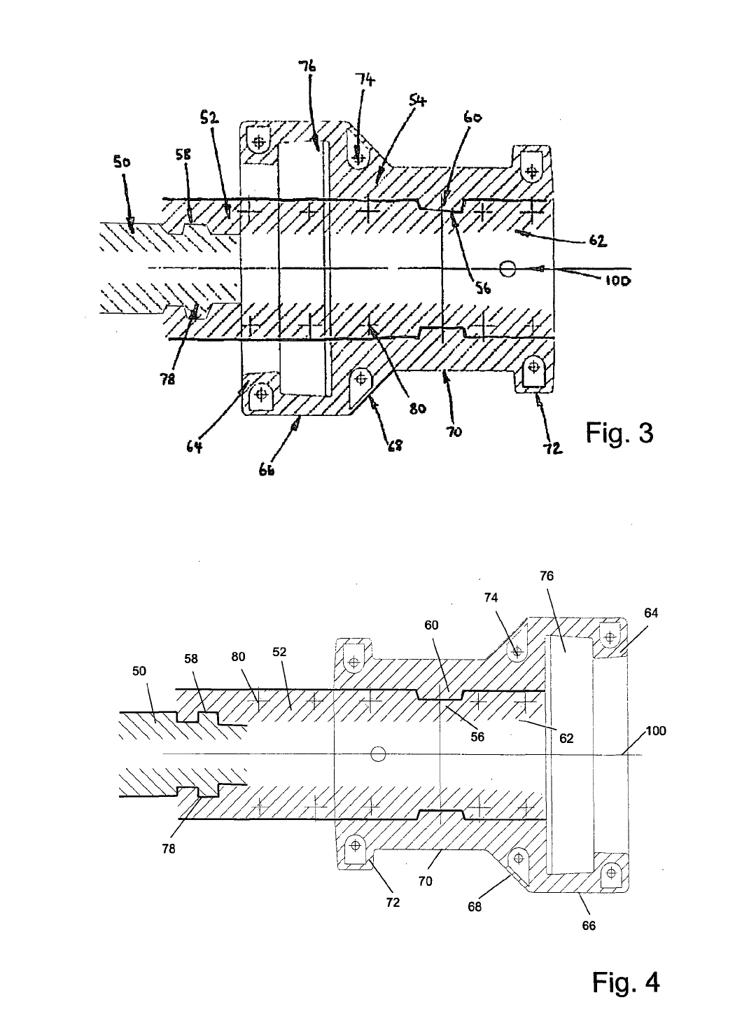

FIG. 3 is a plan view of an interface for coupling the end termination of a tubular member to a bend restrictor string according to the present invention;

FIG. 4 shows how the present invention can be alternatively implemented as a female interface, where the assembly of the bend restrictor string is made towards the interface;

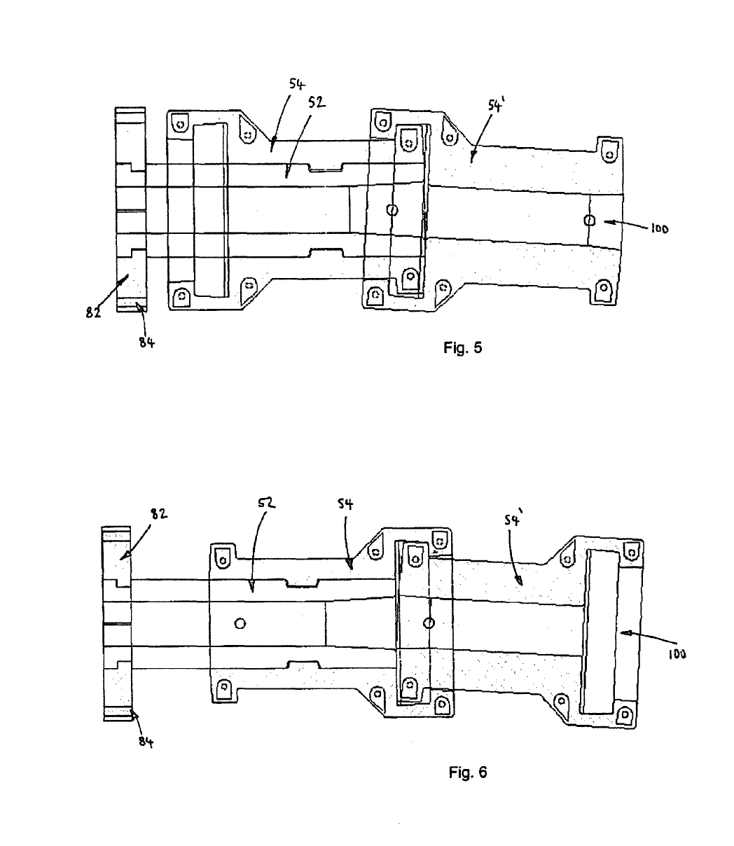

FIG. 5 is a plan view of the interface shown in FIG. 3 which further comprises a flange for connection to rigid structure; and

FIG. 6 is a plan view of the interface shown in FIG. 4 which further comprises a flange for connection to rigid structure.

Referring now to the drawings, an interface 52 for connecting the end termination 50 of a tubular element to a bend restrictor element 54 is shown in FIGS. 3 and 4.

As can be seen, the interface 52 comprises an elongate tubular member which, at its first end, is dimensioned to receive the end termination 50 of a tubular member, and which allows for the first of a plurality of bend restrictor elements 54 to be assembled around the interface 52.

The interface unit 52 and restrictor 54 are formed from two generally semi-circular segmented parts. In FIG. 3, the plane along which adjacent interface 52 and bend restrictor 54 segments are mated is illustrated by apertures 80 on the interface 52 and cutaway apertures 74 on the restrictor 54. To assemble the bend restrictor element 54 around the interface 52, the laterally adjacent parts of the restrictor element 54 are secured to the interface 52, and to neighbouring elements 54′, by a band (not shown) passed around the outer diameter of the bend restrictor element 54 and joined to itself under tension. Suitable banding technology is well known in the art. Alternatively, connecting fasteners through apertures 74 and 80 may be used to secure the two halves of the restrictor 54 and interface 52, respectively, together.

As shown in FIG. 3, one end of the interface 52 includes an internal channel or recess 58 which meets with a corresponding projection or protrusion 78 designed to seat within the recess 58 of the interface 52.

FIG. 3 also shows that the other end interface 52 includes a circumferential groove or recess 56 onto which a bend restricting element 54 which possess a corresponding circumferential protrusion 60 on its internal bore can be located. The groove 56 and protrusion 60 then acting as a locking pair. Whilst FIG. 3 shows the circumferential groove 56 is situated in the interface 52 and the corresponding protrusion being placed in the bend restrictor element 54, the present invention could equally be implemented with a protrusion being placed in the interface 52 and a groove being placed in the bend restrictor element 54.

The other end of the interface 52, opposite to the end termination 50 of a tubular member can be seen to have a modified internal bore 62 which is profiled to ensure a smooth transition exists for the internal tubular member (not shown). The skilled person will appreciate that the end termination 50, interface 52 and restrictor housing element 54 form a continuous, through-going passage or channel 100 for receiving and protecting a flexible elongate member such as a flexible pipework, flowline, power cable and/or umbilical.

The interface 52 is formed from any suitable material including steel with anoids, duplex steel, titanium, composite, nylon or other high strength polymers. It is also envisaged that the interface 52 can be coated with an elastomeric material to provide an even transfer of the load, in use. The interface 52 can also be formed from a material modulus which is suitably designed to provide a deflection sufficient to reduce stresses in the restrictor 54.

FIG. 3 shows that the interface 52 of the present invention can be configured with a “male” orientation of the restrictor housing element 54 where the bend restrictor elements 54, 54′ fit over the interface 52.

The bend restrictor 54 for use with the interface 52 of the present invention is formed from a polymeric material, such as Polyurethane, Nylon or other high strength, typically thermoset, polymers or glass-filled thermoplastics.

The bend restrictor 54, when assembled, is generally tubular in cross section and has at one end a first outer diameter 66 which defines an opening or channel 76 defined by a collar 64. The outer diameter then reduced along ramped section 68 to define a second, smaller outer diameter 70. It is these first and second diameters 66, 70 that can be used to lock the segments together using a band (not shown). The smaller diameter 70 then extends to form a heel 72.

The bend restrictor halves 54 used specifically at the interface 52 can be manufactured in the same manner as the neighbouring elements 54, with the internal bore modified by machining, or a change part in the tooling, through the introduction of a circumferential protrusion 60, designed to seat within the recess 56 of the interface 52.

It is the heel 72 at one end of the restrictor element 54 that is received in the channel 76 in its neighbouring restrictor housing element 54′—as best shown in FIG. 5—that forms a coupling between neighbouring restrictor elements 54, 54′ and which permits movement up to a designed locking radius.

FIG. 5 shows how the male interface 52 of the present invention may be used to assemble a bend restrictor string 54, 54′. Relative angular displacement of longitudinally adjacent bend restrictor elements is limited by abutment of the heel 72 against the circumferential recess or channel 76 in its neighbouring restrictor element 54.

FIG. 5 also shows that the interface connection to the end termination 50 can be improved or enhanced by the inclusion of a segmented fitted flange assembly 80 which again is supplied in respective halves. The flange 80 can then be used to secure the end termination 50 of the flexible pipework to the rigid structure through apertures 82.

FIGS. 4 and 6 show how the same interface 52 can be used to implement a “female” assembly configuration where the bend restrictor element 54 is assembled towards the interface 52. This is achieved simply by rotating the first element 54 of a bend restrictor by 180° and then locking together neighbouring elements 54′ to form a smooth curved locking radius. As can be clearly appreciated, the development of the interface 52 removes the need for any welding and permits assembly both to and from the end termination 50 irrespective of the assembly procedure.

For the avoidance of doubt, the essential feature of the invention is that it allows the placing of a modified bend restrictor segment in either orientation on an interface unit. This can be achieved by a groove or recess on the interface unit which mates with a projection on the modified bend restrictor segment, or vice versa. The modified bend restrictor segment may be male or female. Non-limiting examples of these features are shown as recess 56 in the interface unit and projection 60 in the modified bend restrictor segment in FIGS. 3 and 4. A key advantage is that the end of the bend restrictor can be attached to the same type of interface regardless of whether it is a male end or a female end.

Various alterations and modifications may be made. For example, rather than the bend restrictor segment mating directly with the interface unit, there may be one or more further parts to the assembly which permit indirect mating or locking, for example a locking ring or other device which may mate with both the bend restrictor segment and the interface unit.

1.-38. (canceled)

39. A bend restrictor segment shaped to be coupled to another similarly formed bend restrictor segment to form a bend restrictor element having
a through-going bore for receiving a member to be protected from over-bending;
a female end;
a male end for locating inside the female end of an adjacent, similarly formed bend restrictor element; and
a coupling feature comprising at least one of a projection, a groove and a recess within the through-going bore for coupling the bend restrictor element to an interface unit received in the through-going bore, the bend restrictor segment being suitable for coupling in either orientation to the interface unit.

40. An assembly comprising a bend restrictor element as claimed in claim 39 mounted upon an interface unit, wherein the interface unit comprises at least one of a projection, a groove and a recess for coupling to the coupling feature of the bend restrictor element.

41. An assembly as claimed in claim 40, wherein said at least one of a projection, a groove and a recess of the interface unit complements and mates with said coupling feature of the bend restrictor element.

42. An assembly as claimed in claim 40, wherein said at least one of a projection, a groove and a recess of the interface unit couples with said coupling feature of the bend restrictor element through a further structure between the bend restrictor segment and the interface unit.

43. An assembly as claimed in claim 42, wherein said further structure projects into recesses on both the bend restrictor segment and the interface unit to lock them together.

44. A bend restrictor segment as claimed in claim 39, wherein the coupling feature comprises a circumferential groove.

45. A bend restrictor segment as claimed in claim 44, wherein the groove is not continuous.

46. An interface unit for coupling an elongate member to a bend restrictor, comprising: a segmented tubular body which, when assembled, defines an opening extending therethrough for receiving the elongate member, and having an outer projection or channel that is dimensioned to meet with a complementarily shaped bend restrictor to form an interlock.

47. An interface unit as claimed in claim 46, wherein the interface is rigid and is formed from steel with anodes, duplex steel, Titanium, composite, Nylon or other high strength polymers.

48. An interface unit as claimed in claim 47, wherein the interface unit is coated with a suitable elastomeric material.

49. An, interface unit as claimed in claim 46, wherein the interface unit has a material modulus that is designed to provide a deflection sufficient to reduce mechanical stresses in the bend restrictor.

50. An interface unit as claimed in claim 46, further comprising a collar or flange for attaching to the end termination of the elongate member.

51. An interface unit as claimed in claim 46, wherein the opening extending therethrough has an internal bore that is profiled to ensure a smooth transition exists for the elongate member.

52. An interface unit as claimed in claim 46, wherein the outer projection or channel extends around the circumference.

53. A bend restrictor segment as claimed in claim 39, which is formed from Polyurethane, Nylon or other high-strength thermoset polymers.

54. A bend restrictor segment as claimed in claim 39, which is formed from glass-filled thermoplastics.

55. An interface unit as claimed in claim 46, which is configured as segmented halves.
